(19) United States
(12) Patent Application Publication
(10) Pub. No.: US 2024/0063447 A1
(43) Pub. Date: Feb. 22, 2024

(54) DIRECT PLUG-IN POWER BANK AND POWER BANK PROTECTIVE COVER

(71) Applicant: U2O GLOBAL CO, LTD., Xiamen (CN)

(72) Inventor: Longjie Hong, Xiamen (CN)

(21) Appl. No.: 18/084,556

(22) Filed: Dec. 20, 2022

(30) Foreign Application Priority Data
Aug. 22, 2022 (CN) 202222211587.3

(51) Int. Cl. H01M 10/46; H01M 50/50; H02J 7/00

(52) U.S. Cl. CPC H01M 10/46; H01M 50/50; H02J 7/0042

(57) ABSTRACT

A direct plug-in power bank and a power bank protective cover are disclosed. The direct plug-in power bank includes a power bank body and an output connector detachably mounted to the power bank body. A movable restricting member of the power bank body is movably fitted with a first restricting portion of the output connector for restricting the output connector. The connection between the power bank body and the output connector is stable and reliable, thereby improving user experience.

### BACKGROUND OF THE INVENTION

### 1. Field of the Invention

The present invention relates to a direct plug-in power bank, and more particularly to a direct plug-in power bank and a power bank protective cover.

### 2. Description of the Prior Art

Chinese Patent Publication No. CN216085528U discloses a power bank with a replaceable charging connector. The charging connector can be replaced with a different one to match a corresponding charging interface of a mobile phone, having higher versatility. However, there are other problems. The charging connector serves as an output connector. The output connector is directly inserted and installed on the power output socket, without any restricting structure. It is difficult to guarantee the stability of the installation. It is easy to have poor circuit contact, which will affect the charging effect of the mobile phone. When the mobile phone needs to be separated from the power bank after the charging of the mobile phone is completed, the output connector is easily disconnected from the power output socket to be on the charging interface of the mobile phone. This brings inconvenience to users and affects user experience. In addition, because the output connector is small in size, it is inconvenient to store the removed output connector when it is replaced. There is a greater possibility of loss, resulting in unnecessary damage.

### SUMMARY OF THE INVENTION

The primary object of the present invention is to provide a direct plug-in power bank and a power bank protective cover, so as to solve the above-mentioned technical problems.

In order to achieve the above object, the present invention adopts the following solutions.

The present invention provides a direct plug-in power bank. The direct plug-in power bank comprises a power bank body and an output connector detachably mounted to the power bank body. The power bank body includes a power output portion, a mounting hole, and a movable restricting member. The output connector includes a power output matching portion and a first restricting portion. The output connector is insertedly connected to the mounting hole to realize electrical connection between the power output matching portion and the power output portion. The movable restricting member is movably fitted with the first restricting portion for restricting the output connector so that the output connector can be detachably mounted to the power bank body.

In an embodiment, the power bank body includes a casing. The first restricting portion is a restricting channel. The movable restricting member is slidably disposed on the casing. The movable restricting member is movably fitted with the restricting channel by sliding for restricting the output connector.

Wherein, the output connector is inserted in a front-to-back direction. The movable restricting member is slid in a left-to-right direction. The movable restricting member is movably fitted with the restricting channel by sliding left and right for restricting the output connector in the front-to-back direction.

Wherein, the power bank body further includes an elastic hook. The output connector further includes a second restricting portion. The elastic hook cooperates with the second restricting portion to form a hook restricting structure.

Wherein, the elastic hook includes two elastic hooks that are arranged opposite to each other and located at left and right sides of the power output portion. The second restricting portion includes two second restricting portions that are metal conductive sheets oppositely disposed on left and right sides of the output connector respectively. The elastic hooks are electrically connected to the metal conductive sheets and cooperate with the metal conductive sheets to form the hook restricting structure.

Wherein, the power bank body includes the casing, a guide mounting seat, a battery, and a circuit board. A charging interface and a charging switch are disposed on two ends of the circuit board, respectively. The power output portion is disposed on a middle portion of the circuit board. The mounting hole is defined in the casing. The guide mounting seat is mounted in the mounting hole and corresponds to the power output portion.

Wherein, atop of the guide mounting seat is formed with a first receiving hole. Left and right sides of the guide mounting seat are formed with second receiving holes. The movable restricting member passes through the first receiving hole to be movably fitted with the first restricting portion. The elastic hooks pass through the respective second receiving holes and cooperate with the respective second restricting portions to form the hook restricting structure.

In an embodiment, the power bank body includes a casing and a spring. The movable restricting member cooperates with the spring and is mounted on the casing to be pressed up and down. The movable restricting member includes two restricting blocks. The first restricting portion includes two restricting portions. The two first restricting portions are in the form of two vertical engaging openings respectively disposed on left and right sides of the output connector. The restricting blocks of the movable restricting member are movably fitted with the respective vertical engaging openings for restricting the output connector.

In an embodiment, the power bank body includes a casing and a spring. The movable restricting member cooperates with the spring and is mounted on the casing to be turned forward and backward. An upper portion of the movable restricting member is defined as a switching portion. A lower portion of the movable restricting member is defined as a restricting portion. The first restricting portion is a restricting protrusion disposed on an upper side of the output connector. The restricting portion of the movable restricting member is movably fitted with the restricting protrusion for restricting the output connector.

The present invention further comprises a power bank protective cover. The foregoing direct plug-in power bank is placed in the power bank protective cover. The power bank protective cover comprises an upper cover body and a lower cover body that are buckled in an upper-to-lower direction. The lower cover body includes a protective cap and an accommodating groove. The protective cap is configured to cover and protect the output connector mounted to the power bank body. The accommodating groove is configured to accommodate the output connector detached from the power bank body.

The present invention has the following beneficial effects:
1. In the present invention, the movable restricting member and the elastic hook are movably fitted with the first restricting portion and the second restricting portion respectively for restricting the output connector, so that the output connector can be mounted to the power bank body stably and reliably. Further, it is ensured that the electrical connection between the power output matching portion and the power output portion is stable and reliable, so as to avoid poor circuit contact and ensure the charging effect of the mobile phone. After the mobile phone is charged and when the mobile phone needs to be separated from the power bank, the output connector will not be detached from the power bank body to be on the charging interface of the mobile phone, so as to improve the user experience.
2. The power bank protective cover of the present invention comprises an upper cover body and a lower cover body that are buckled in an upper-to-lower direction. The lower cover body includes a protective cap and an accommodating groove. The protective cap is configured to cover and protect the output connector mounted to the power bank body. The accommodating groove is configured to accommodate the output connector detached from the power bank body, so that the output connector after being removed can be stored in the accommodating groove, thereby avoiding loss of the output connector.

### BRIEF DESCRIPTION OF THE DRAWINGS

FIG. 1 is a front view of the direct plug-in power bank and the power bank protective cover after being assembled according to a first embodiment of the present invention;

FIG. 2 is a rear view of the direct plug-in power bank and the power bank protective cover after being assembled according to the first embodiment of the present invention;

FIG. 3 is a right view of the direct plug-in power bank and the power bank protective cover after being assembled according to the first embodiment of the present invention;

FIG. 4 is an exploded view of the power bank body and the output connector according to the first embodiment of the present invention;

FIG. 5 is a schematic view of the internal structure of the direct plug-in power bank according to the first embodiment of the present invention;

FIG. 6 is an exploded view of the direct plug-in power bank according to the first embodiment of the present invention;

FIG. 7 is a schematic view of the guide mounting seat according to the first embodiment of the present invention;

FIG. 8 is a schematic view of the output connector according to the first embodiment of the present invention;

FIG. 9 is a perspective view of the power bank protective cover according to the first embodiment of the present invention;

FIG. 10 is a schematic view of the interior of the power bank protective cover according to the first embodiment of the present invention;

FIG. 11 is a front view of the direct plug-in power bank and the power bank protective cover after being assembled according to a second embodiment of the present invention;

FIG. 12 is an exploded view of the direct plug-in power bank according to the second embodiment of the present invention;

FIG. 13 is a front view of the direct plug-in power bank and the power bank protective cover after being assembled according to a third embodiment of the present invention; and

FIG. 14 is an exploded view of the direct plug-in power bank according to the third embodiment of the present invention.

### DETAILED DESCRIPTION OF THE PREFERRED EMBODIMENTS

Embodiments of the present invention will now be described, by way of example only, with reference to the accompanying drawings. These drawings are part of the disclosure of the present invention for illustrating the embodiments, in conjunction with the relevant description of the specification to explain the operation principles of the embodiments. With reference to the specification, a person skilled in the art will understand other possible embodiments and advantages of the present invention. Components in the drawings are not drawn to scale. Similar component numerals represent similar components.

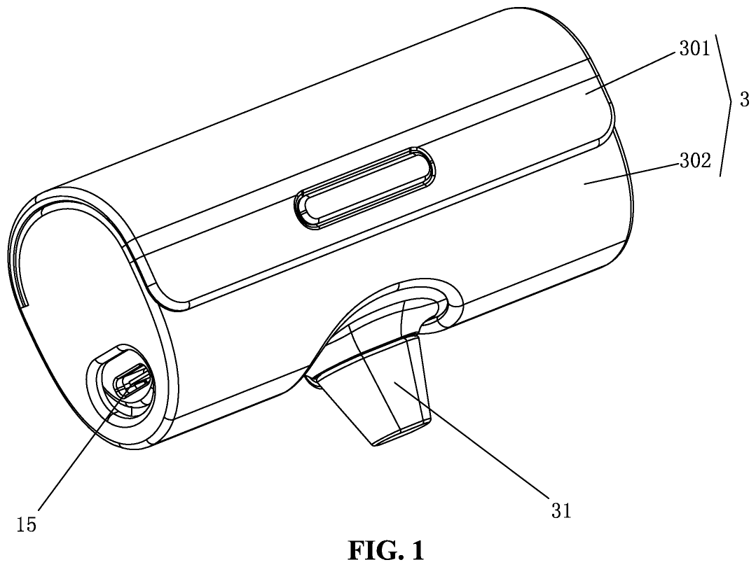

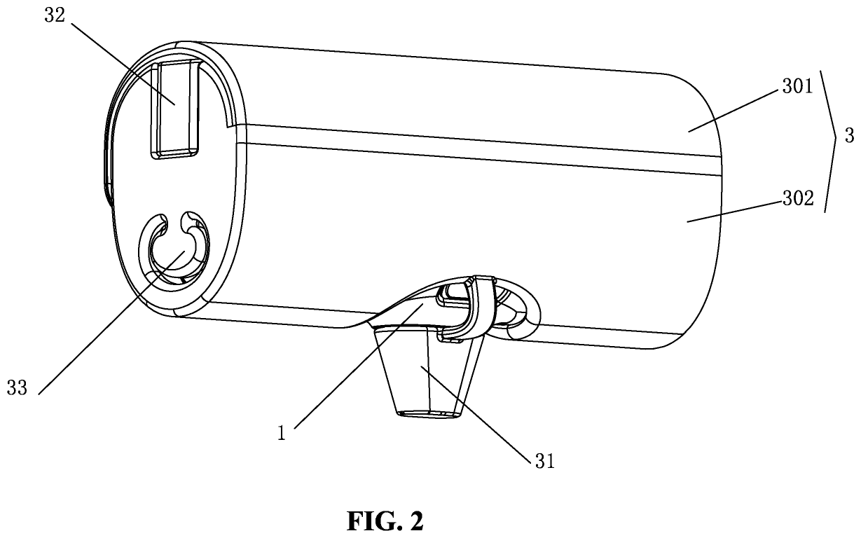

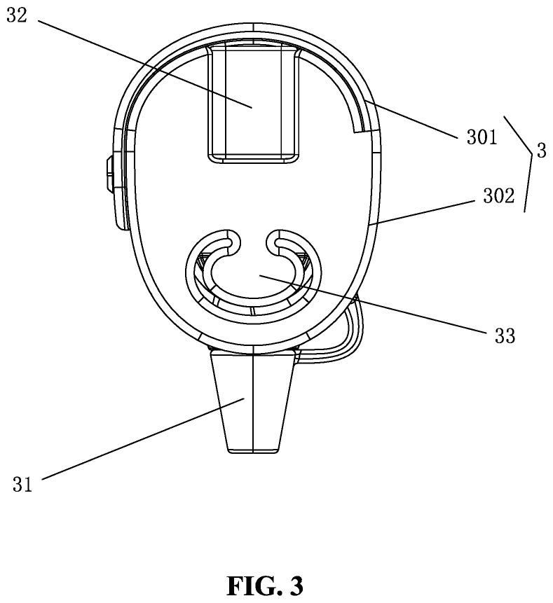

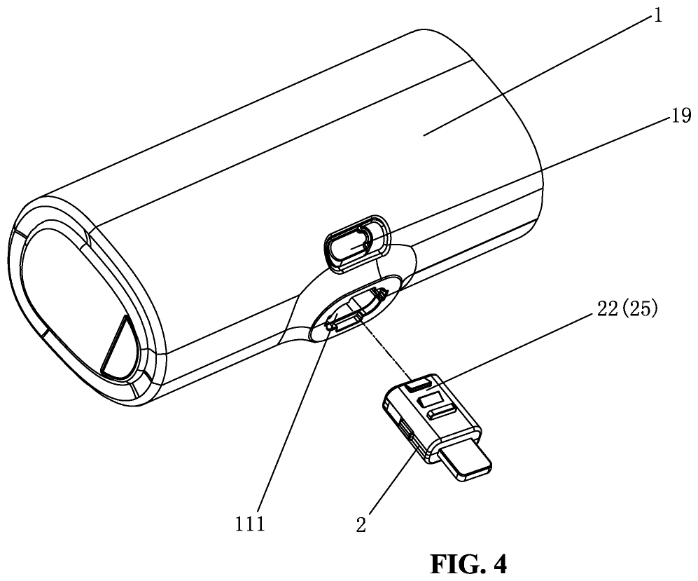

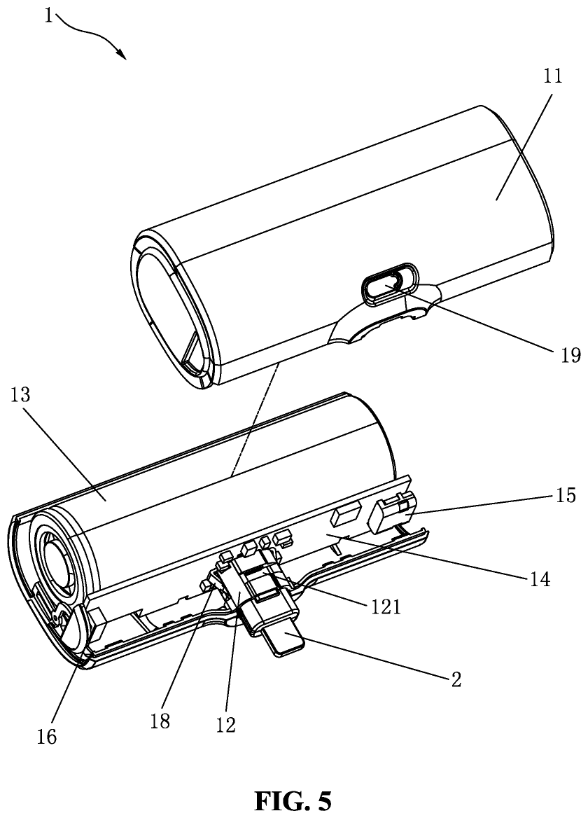

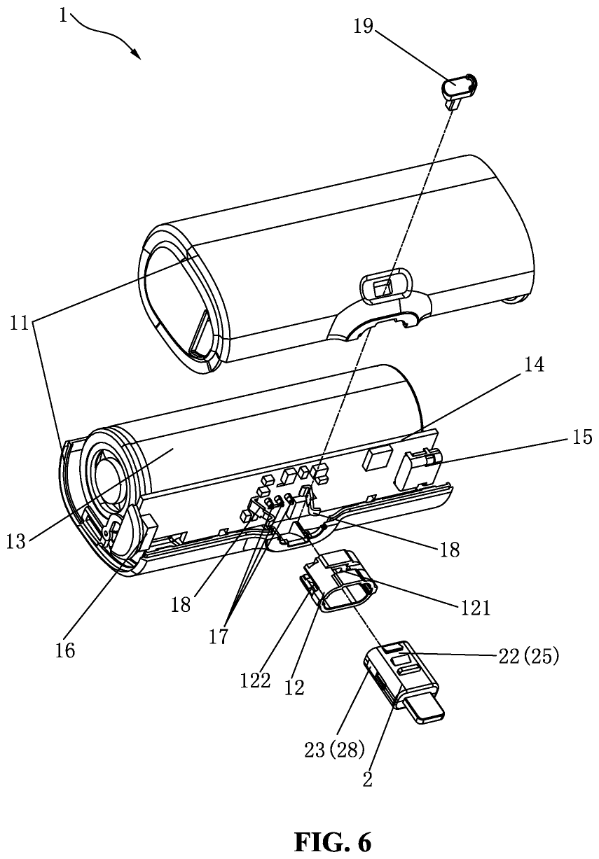

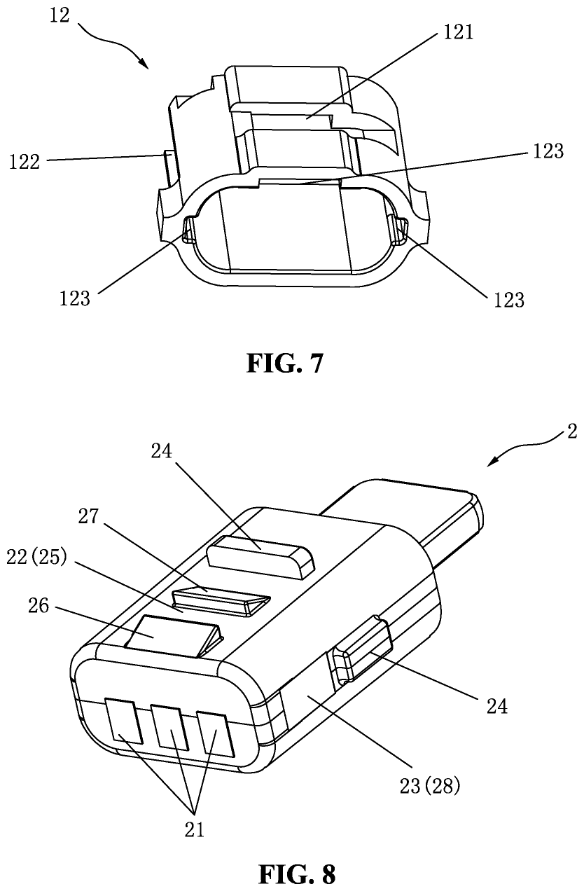

FIGS. 1 to 10 illustrate a first embodiment of the present invention. The present invention discloses a direct plug-in power bank with a replaceable output connector. The direct plug-in power bank comprises a power bank body 1 and an output connector 2 detachably mounted to the power bank body 1. The power bank body 1 includes a power output portion 17, a guide mounting seat 12, a mounting hole 111, and a movable restricting member 19. The output connector 2 includes a power output matching portion 21 and a first restricting portion 22. The power output portion 17 is three electrical pins. The power output matching portion 21 is three electrical jacks. The output connector 2 is insertedly connected to the guide mounting seat 12 via the mounting hole 111. In the present invention, the electrical connection between the power output matching portion 21 and the power output portion 17 is realized by the cooperation between the electrical pins and the electrical jacks. The movable restricting member 19 is movably fitted with first restricting portion 22 for restricting the output connector 2, so that the output connector 2 can be detachably mounted to the power bank body 1. Because the charging interface 15 of electronic products, such as mobile phones and tablet computers, is generally a MicroUSB interface, a Type-C interface or a Lightning interface, the output connector 2 may be any one of a MicroUSB connector, a Type-C connector or a Lightning connector to ensure that it can meet the needs of most electronic products.

In the above technical solution, the movable restricting member 19 cooperates with the first restricting portion 22 to restrict the output connector 2, so that the output connector 2 can be mounted to the power bank body 1 stably and reliably. Further, it is ensured that the electrical connection between the power output matching portion 21 and the power output portion 17 is stable and reliable, so as to avoid poor circuit contact and ensure the charging effect of the mobile phone. After the mobile phone is charged and when the mobile phone needs to be separated from the power bank, the output connector 2 will not be detached from the power bank body 1 to be on the charging interface of the mobile phone, so as to improve the user experience.

In the first embodiment, the output connector 2 may be an output connector or an input/output connector, but not limited thereto.

In the first embodiment, the power bank body 1 further includes an elastic hook 18. The output connector 2 further includes a second restricting portion 23. The elastic hook 18 cooperates with the second restricting portion 23 to form a hook restricting structure. Specifically, the elastic hook 18 includes two elastic hooks 18 that are arranged opposite to each other and located at the left and right sides of the power output portion 17. The second restricting portion 23 includes two second restricting portions 23 that are metal conductive sheets 28 oppositely disposed on the left and right sides of the output connector 2 respectively. The two metal conductive sheets 28 are positive and negative metal conductive sheets for realizing the charging function. The elastic hooks 18 are electrically connected to the metal conductive sheets 28 and cooperate with the metal conductive sheets 28 to form the hook restricting structure. The stability of the restriction is higher. The installation stability of the output connector 2 is further improved.

In the first embodiment, the top of the guide mounting seat 12 is formed with a first receiving hole 121. The left and right sides of the guide mounting seat 12 are formed with second receiving holes 122. The movable restricting member 19 passes through the first receiving hole 121 to be movably fitted with the first restricting portion 22. The elastic hooks 18 pass through the respective second receiving holes 122 and cooperate with the respective second restricting portions 23 to form the hook restricting structure. This improves the installation stability of the guide mounting seat 12.

Specifically, the first restricting portion 22 is a restricting channel 25. The top wall of the output connector 2 is formed with a first rib 26 and a second rib 27. The restricting channel 25 is defined between the first rib 26 and the second rib 27. The movable restricting member 19 is slidably disposed on a casing 11. The movable restricting member 19 is movably fitted with the restricting channel 25 by sliding for restricting the output connector 2. Further, the output connector 2 is inserted in a front-to-back direction.

The movable restricting member 19 is slid in a left-to-right direction. The movable restricting member 19 is movably fitted with the restricting channel 25 by sliding left and right for restricting the output connector 2 in the front-to-back direction. The second receiving hole 122 is designed into a gradient configuration with left high and right low. When the output connector 2 is insertedly connected to the guide mounting seat 12, the left side wall of the second receiving hole 122 can block and restrict the left opening of the restricting channel 25, so that the movable restricting member 19 can slide left into the restricting channel 25, so as to restrict the output connector 2 in the front-to-back direction. The right side wall of the second receiving hole 122 gives way to the right opening of the restricting channel 25, so that the movable restricting member 19 can slide right to be out of the restricting grove 25, thereby releasing the restriction on the output connector 2 in the front-to-back direction.

Of course, in other embodiments, the movable restricting member 19 may be movably fitted with the restricting channel 25 by sliding up and down for restricting the output connector 2 in the front-to-back direction.

In the first embodiment, the power bank body 1 includes a casing 11, a battery 13, and a circuit board 14. A charging interface 15 and a charging switch 16 are disposed on two ends of the circuit board 14, respectively. The power output portion 17 is disposed on a middle portion of the circuit board 14. The mounting hole 111 is defined in the casing 11. The guide mounting seat 12 is mounted in the mounting hole 111 and corresponds to the power output portion 17. The layout of the charging interface 15, the charging switch 16, and the power output portion 17 is reasonable. The operation is more convenient and conforms to people's usage habits.

In the first embodiment, the output connector 2 further has a plurality of restricting raised blocks 24. The inner wall of the guide mounting seat 12 has a plurality of restricting grooves 123. The restricting raised blocks 24 are fitted with the restricting grooves 123 for restricting the output connector 2. Specifically, the output connector 2 has three restricting raised blocks 24 respectively disposed on the left and right sides and the top of the output connector 2. The inner wall of the guide mounting seat 12 has three restricting grooves 123 respectively disposed on the inner walls of the left and right sides and the top of the guide mounting seat 12.

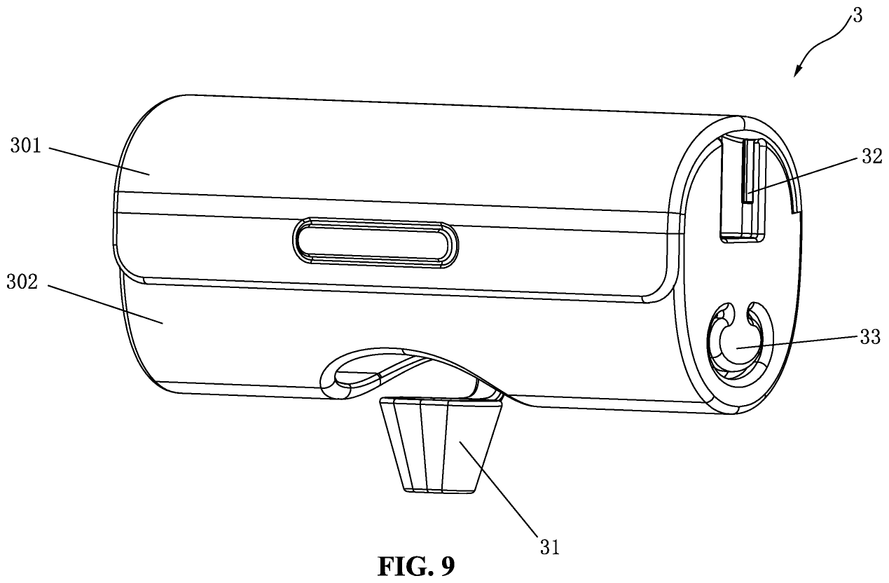

Referring to FIG. 9 and FIG. 10, the present invention further provides a power bank protective cover. The foregoing direct plug-in power bank is placed in the power bank protective cover 3. The power bank protective cover 3 includes an upper cover body 301 and a lower cover body 302 that are buckled in an upper-to-lower direction. The upper cover body 301 and the lower cover body 302 are integrally connected. The lower cover body 302 includes a protective cap 31 and an accommodating groove 32. The protective cap 31 is configured to cover and protect the output connector 2 mounted to the power bank body 1. The accommodating groove 32 is configured to accommodate the output connector 2 detached from the power bank body 1, so that the output connector 2 after being removed can be stored in the accommodating groove 32, thereby avoiding loss of the output connector 2.

Specifically, the accommodating groove 32 is disposed on one end of the lower cover body 302 in the longitudinal direction. When the upper cover body 301 and the lower cover body 302 are buckled in the upper-to-lower direction, the upper cover body 301 can cover the top of the accommodating groove 32 to prevent the output connector 2 stored in the accommodating groove 32 from coming off the accommodating groove 32 due to looseness, thereby further improving the protection effect.

In the first embodiment, the lower cover body 302 further has a press portion 33 corresponding to the charging switch 16 of the power bank and a charging interface opening 34 corresponding to the charging interface 15 of the power bank. A protruding post 331 is formed on the inner side of the press portion 33 to shorten the press stroke and improve the user experience.

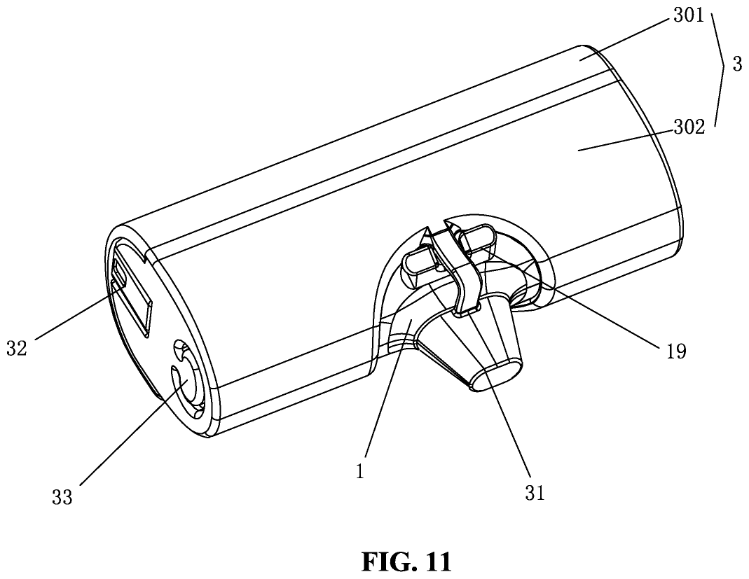

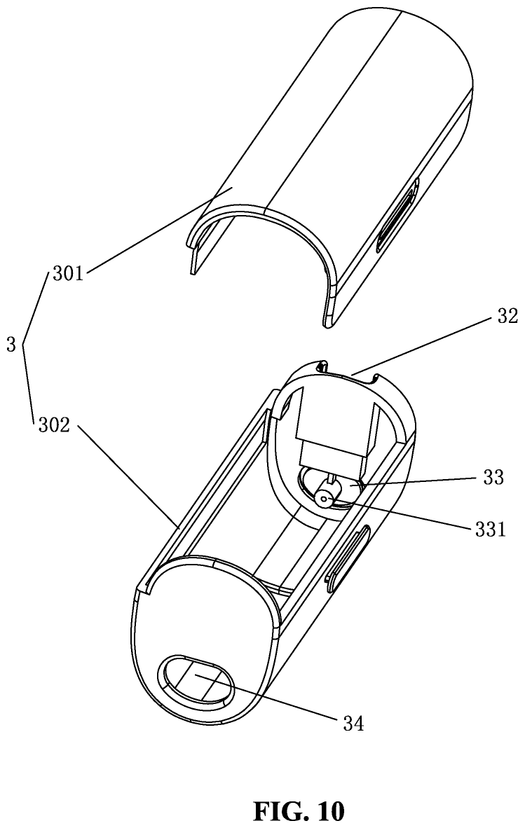

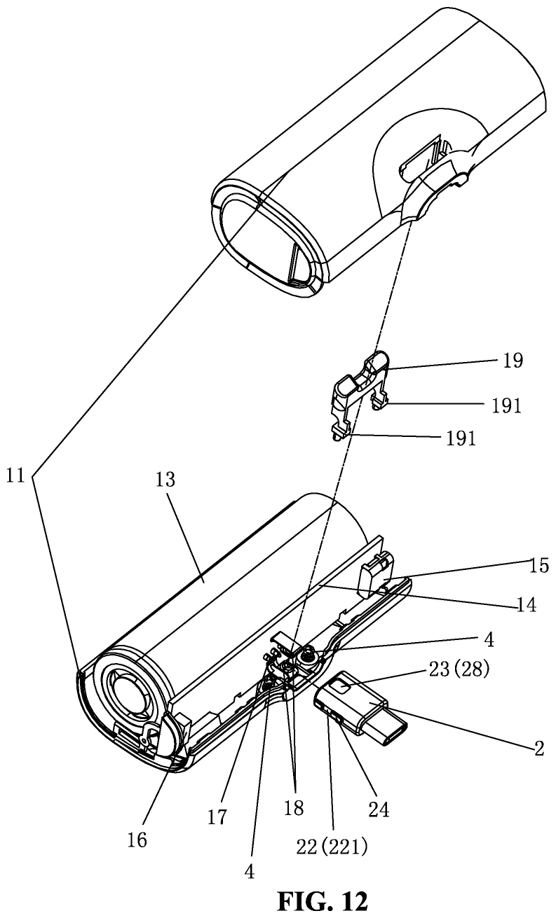

FIG. 11 and FIG. 12 illustrate a second embodiment of the present invention. The second embodiment is substantially similar to the first embodiment with the exceptions described hereinafter. The present invention provides a direct plug-in power bank with a replaceable output connector. The direct plug-in power bank comprises a power bank body 1 and an output connector 2 detachably mounted to the power bank body 1. The power bank body 1 includes a casing 11, a spring 4, a battery 13 and a circuit board 14, without a guide mounting seat. The movable restricting member 19 cooperates with the spring 4 and is mounted on the casing 11 to be pressed up and down. The movable restricting member 19 includes two restricting blocks 191. The first restricting portion 22 includes two restricting portions 22. The two first restricting portions 22 are in the form of two vertical engaging openings 221 respectively disposed on the left and right sides of the output connector 2. The restricting blocks 191 are movably fitted with the vertical engaging openings 221, respectively. When the movable restricting member 19 is moved downward by exerting a force, the restricting blocks 191 are disengaged from the vertical engaging openings 221, so that the output connector 2 can be detached from the power bank body 1. When the movable restricting member 19 is elastically moved upward by releasing the force, the restricting blocks 191 are engaged with the vertical engaging openings 221, so that the output connector 2 can be mounted to the power bank body 1 stably and reliably.

The elastic hook 18 includes two elastic hooks 18 that are arranged opposite to each other and located at the upper and lower sides of the power output portion 17. The second restricting portion 23 includes two second restricting portions 23 that are metal conductive sheets 28 oppositely disposed on the upper and lower sides of the output connector 2 respectively. The elastic hooks 18 are electrically connected to the metal conductive sheets 28 and cooperate with the metal conductive sheets 28 to form the hook restricting structure.

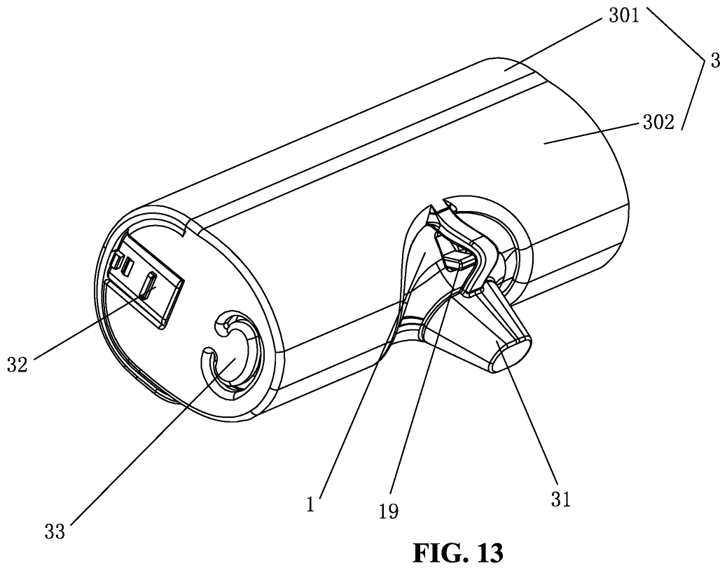

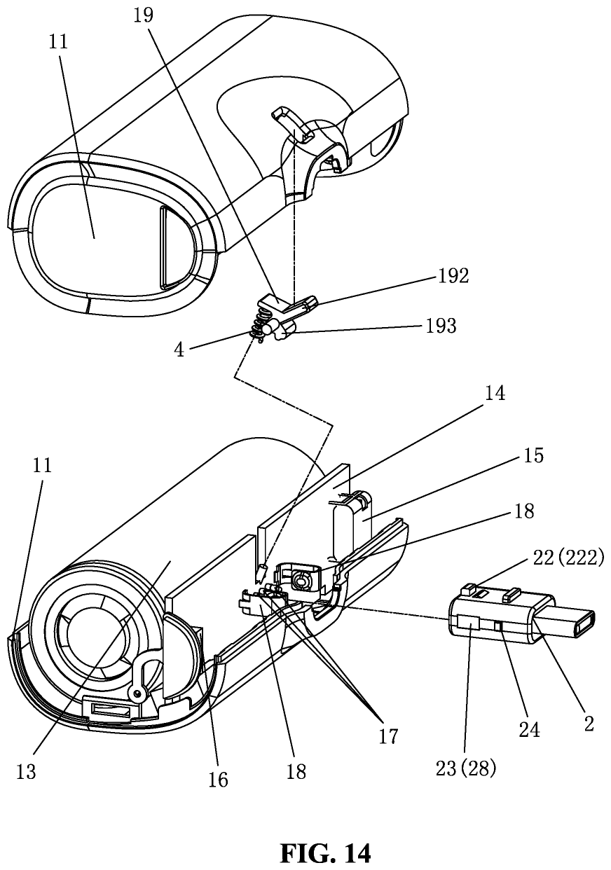

FIG. 13 and FIG. 14 illustrate a third embodiment of the present invention. The third embodiment is substantially similar to the second embodiment with the exceptions described hereinafter. The present invention provides a direct plug-in power bank with a replaceable output connector. The direct plug-in power bank comprises a power bank body 1 and an output connector 2 detachably mounted to the power bank body 1. The power bank body 1 includes a casing 11, a spring 4, a battery 13 and a circuit board 14, without a guide mounting seat. The movable restricting member 19 cooperates with the spring 4 and is mounted on the casing 11 to be turned forward and backward. The upper portion of the movable restricting member 19 is defined as a switching portion 192. The lower portion of the movable restricting member 19 is defined as a restricting portion 193. The first restricting portion 22 is a restricting protrusion 222 disposed on the upper side of the output connector 2. The restricting portion 193 of the movable restricting member 19 is movably fitted with the restricting protrusion 222 for restricting the output connector 2. When the switching portion 192 is turned backward by exerting a force, the restricting portion 193 is disengaged from the restricting protrusion 222, so that the output connector 2 can be detached from the power bank body 1. When the switching portion 192 is elastically turned forward by releasing the force, the restricting portion 193 is fitted with the restricting protrusion 222, so that the output connector 2 is mounted to the power bank body 1 stably and reliably.

The elastic hook 18 includes two elastic hooks 18 that are arranged opposite to each other and located at the left and right sides of the power output portion 17. The second restricting portion 23 includes two second restricting portions 23 that are metal conductive sheets 28 oppositely disposed on the left and right sides of the output connector 2 respectively. The elastic hooks 18 are electrically connected to the metal conductive sheets 28 and cooperate with the metal conductive sheets 28 to form the hook restricting structure.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A direct plug-in power bank, comprising a power bank body and an output connector detachably mounted to the power bank body, the power bank body including a power output portion, a mounting hole and a movable restricting member, the output connector including a power output matching portion and a first restricting portion; the output connector being insertedly connected to the mounting hole to realize electrical connection between the power output matching portion and the power output portion, the movable restricting member being movably fitted with the first restricting portion for restricting the output connector so that the output connector can be detachably mounted to the power bank body.

2. The direct plug-in power bank as claimed in claim 1, wherein the power bank body includes a casing, the first restricting portion is a restricting channel, the movable restricting member is slidably disposed on the casing, and the movable restricting member is movably fitted with the restricting channel by sliding for restricting the output connector.

3. The direct plug-in power bank as claimed in claim 2, wherein the output connector is inserted in a front-to-back direction, the movable restricting member is slid in a left-to-right direction; the movable restricting member is movably fitted with the restricting channel by sliding left and right for restricting the output connector in the front-to-back direction.

4. The direct plug-in power bank as claimed in claim 3, wherein the power bank body further includes an elastic hook, the output connector further includes a second restricting portion, and the elastic hook cooperates with the second restricting portion to form a hook restricting structure.

5. The direct plug-in power bank as claimed in claim 4, wherein the elastic hook includes two elastic hooks that are arranged opposite to each other and located at left and right sides of the power output portion;
the second restricting portion includes two second restricting portions that are metal conductive sheets oppositely disposed on left and right sides of the output connector respectively; the elastic hooks are electrically connected to the metal conductive sheets and cooperate with the metal conductive sheets to form the hook restricting structure.

6. The direct plug-in power bank as claimed in claim 4, wherein the power bank body includes the casing, a guide mounting seat, a battery and a circuit board, a charging interface and a charging switch are disposed on two ends of the circuit board respectively, the power output portion is disposed on a middle portion of the circuit board, the mounting hole is defined in the casing, and the guide mounting seat is mounted in the mounting hole and corresponds to the power output portion.

7. The direct plug-in power bank as claimed in claim 6, wherein a top of the guide mounting seat is formed with a first receiving hole, left and right sides of the guide mounting seat are formed with second receiving holes, the movable restricting member passes through the first receiving hole to be movably fitted with the first restricting portion, the elastic hooks pass through the respective second receiving holes and cooperate with the respective second restricting portions to form the hook restricting structure.

8. The direct plug-in power bank as claimed in claim 1, wherein the power bank body includes a casing and a spring, the movable restricting member cooperates with the spring and is mounted on the casing to be pressed up and down, the movable restricting member includes two restricting blocks;
the first restricting portion includes two restricting portions, the two first restricting portions are in the form of two vertical engaging openings respectively disposed on left and right sides of the output connector, the restricting blocks of the movable restricting member are movably fitted with the respective vertical engaging openings for restricting the output connector.

9. The direct plug-in power bank as claimed in claim 1, wherein the power bank body includes a casing and a spring, the movable restricting member cooperates with the spring and is mounted on the casing to be turned forward and backward, an upper portion of the movable restricting member is defined as a switching portion, a lower portion of the movable restricting member is defined as a restricting portion;
the first restricting portion is a restricting protrusion disposed on an upper side of the output connector, the restricting portion of the movable restricting member is movably fitted with the restricting protrusion for restricting the output connector.

10. A power bank protective cover for the direct plug-in power bank as claimed in claim 1 to be placed in the power bank protective cover, comprising an upper cover body and a lower cover body that are buckled in an upper-to-lower direction, the lower cover body including a protective cap and an accommodating groove, the protective cap being configured to cover and protect the output connector mounted to the power bank body, the accommodating groove being configured to accommodate the output connector detached from the power bank body.
